(19) United States
(12) Patent Application Publication
(10) Pub. No.: US 2018/0285068 A1
(43) Pub. Date: Oct. 4, 2018

(54) PROCESSING METHOD OF AUDIO CONTROL AND ELECTRONIC DEVICE THEREOF

(71) Applicant: Lenovo (Beijing) Co., Ltd., Beijing (CN)

(72) Inventor: Jianqiang LU, Beijing (CN)

(21) Appl. No.: 15/920,965

(22) Filed: Mar. 14, 2018

(30) Foreign Application Priority Data
Mar. 30, 2017 (CN) 201710203503.2

(51) Int. Cl. G06F 3/16; G08C 23/02

(52) U.S. Cl. CPC G06F 3/167; G08C 23/02

(57) ABSTRACT

The present disclosure provides a processing method of audio control and an electronic device implementing the processing method. The method for audio control for an electronic device includes receiving, using a processor, a first audio input; activating, using a processor, an audio controlled function of an electronic device in response to the first audio input; receiving, using a processor, a second audio input; determining, using a processor, whether the second audio input is an audio control for the electronic device; and responding, using a processor, to the second audio input in response to a determination result.

### CROSS-REFERENCES TO RELATED APPLICATIONS

This application claims the priority of Chinese Patent Application No. 201710203503.2, entitled “Processing Method and Electronic Device thereof,” filed on Mar. 30, 2017, the entire content of which is incorporated herein by reference.

### FIELD OF THE DISCLOSURE

The present disclosure relates to the field of audio control technologies and, more particularly, relates to a processing method of audio control and an electronic device thereof.

### BACKGROUND

With continued development of smart terminals, and as an important part of the smart terminals, speech recognition technologies for smart terminals are fast evolving. A variety of speech recognition products have been brought to market, thereby making interactions between users and smart terminals easier and more interesting.

In order for users to avoid faulty operations of smart terminals, wake-up instructions may be set to control smart terminals. As smart terminals receive those wake-up instructions, which often refer to the terminals themselves, a subsequent collection of audio inputs may be expected. Based on the subsequently received audio inputs, corresponding control operations on the smart terminals may be performed. However, a smart terminal may receive terms similar to its wake-up instructions from various sources by mistake. This may cause the smart terminal to use the subsequent audio inputs as control instructions by mistake and performs one or more unintended operations.

The disclosed method and device are directed to solve one or more problems set forth above and other problems.

### BRIEF SUMMARY OF THE DISCLOSURE

In view of the foregoing, one aspect of the present disclosure provides a processing method of audio control to prevent faulty operations in which the electronic device responds to a detected audio input which is not intended to control the electronic device itself.

In order to achieve the objectives, the present disclosure provides a processing method of audio control, which may comprise monitoring audio inputs. The processing method for audio control for an electronic device includes receiving, using a processor, a first audio input; activating, using a processor, an audio controlled function of an electronic device in response to the first audio input; receiving, using a processor, a second audio input; determining, using a processor, whether the second audio input is an audio control for the electronic device; and responding, using a processor, to the second audio input in response to a determination result.

In some embodiments, the method may further include obtaining a first processing result of the second audio input, the first processing result indicating whether the second audio input corresponds to a control instruction of the electronic device; and obtaining, using a processor, a second processing result of the second audio input if the second audio input does not corresponding to any control instruction of the electronic device, the second processing result indicating whether the second audio input satisfies a first condition or a second condition.

In some embodiments, the method may further include outputting, using a processor, the first processing result, if the second audio input satisfies the first condition, and the first processing result indicates the second audio input not corresponding to any control instruction of the electronic device; and responding, using a processor, to the second audio input corresponding to the control instruction, if the second processing result indicate the second audio input satisfying the first condition, and the first processing result indicates the second audio input corresponding to the control instruction.

In some embodiments, the method may further include obtaining, using a processor, the second processing result of the second audio input to determine whether an audio input feature of the second audio input corresponds to a feature range of human voice, including: determining, using a processor, that the second processing result indicates the second audio input satisfying the first condition, if the audio input feature of the second audio input corresponds to the feature range of human voice; and determining, using a processor, that the second processing result indicates the second audio input satisfying the second condition, if the audio input feature of the second audio input does not correspond to the feature range of human voice.

Further, the feature range of human voice comprises one or more of a decibel range and a frequency range.

In some embodiments, the method may further include obtaining the second processing result of the second audio input to determine whether an audio input feature of the second audio input corresponds to an audio input feature of at least one user, including: determining, using a processor, that the second processing result indicates the second audio input satisfying the first condition, if the audio input feature of the second audio input corresponds to the audio input feature of the at least one user; and determining, using a processor, that the second processing result indicates the second audio input satisfying the second condition, if the audio input feature of the second audio input does not correspond to the audio input feature of the at least one user.

Further, the audio input feature comprises at least one of voiceprint, decibel, frequency, tone, pitch, and audio input intensity.

In some embodiments, the method may further include obtaining, using a processor, a first processing result of the second audio input indicating whether the second audio input corresponds to at least one control instruction of the electronic device, including determining that the first processing result indicates the second audio input satisfying the first condition, if the second audio input corresponds to the at least one control instruction of the electronic device; and determining, using a processor, that the first processing result indicates the second audio input satisfying the second condition, if the second audio input does not correspond to any control instruction of the electronic device.

In some embodiments, the method may further include determining, using a processor, at least one target control phrase contained in the second audio input; comparing, using a processor, the at least one target control phrase with a set of control phrases, each of the set of control phrases corresponding to at least one control instruction of the electronic device; determining, using a processor, the second audio input not corresponding to the at least one control instruction, if the at least one target control phrase is in the set of control phrases; and determining, using a processor, the second audio input corresponding to the at least one control instruction, if the at least one target control phrase is in the set of control phrases.

Further, the at least one target control phrase is determined by parsing a text corresponding to the second audio input into a phrase list and selected from the phrase list.

In response to the determination result indicating the second audio input is not an audio control for the electronic device, the method may further include turning off, using a processor, the audio controlled function.

Another aspect of the present disclosure provides an electronic device comprising a microphone and a processor, with the processor having access to the microphone and a memory which stores instructions executable by the processor to: activate an audio controlled function of the electronic device, in response to receiving a first audio input satisfying a triggering condition; instruct the microphone to obtain a second audio input after obtaining the first audio input; receive the second audio input; obtain a processing result of the second audio input; respond to the second audio input in response to the processing result indicating the second audio is an audio control for the electronic device; and ignore the second audio input in response to the processing result indicating the second audio input is not an audio control for the electronic device.

The processor performs a method for operating audio control for the electronic device. The method comprising activating an audio control function of the electronic device, in response to receiving a first audio input satisfying a triggering condition; instructing the microphone to obtain a second audio input after obtaining the first audio input; receiving the second audio input; obtaining a processing result of the second audio input; responding to the second audio input in response to the processing result indicating the second audio is an audio control for the electronic device; and ignoring the second audio input in response to the processing result indicating the second audio input is not an audio control for the electronic device.

In some embodiments, the method may further include obtaining a first processing result of the second audio input, the first processing result indicating whether the second audio input corresponds to at least one control instruction of the electronic device; and obtaining a second processing result of the second audio input, in response to the first processing result indicating the second audio input not corresponding to any control instruction, the second processing result indicating whether the second audio input satisfies a first condition or a second condition.

In some embodiments, the method may further include obtaining the processing result of the second audio input indicating whether the second audio input corresponds to at least one control instruction for the electronic device; determining that the processing result indicates the second audio input satisfying the first condition in response to the second audio input corresponding to the at least one control instruction for the electronic device; and determining that the processing result indicates the second audio input satisfying the second condition in response to the second audio input not corresponding to any control instruction for the electronic device.

Another aspect of the present disclosure provides a cloud server monitoring an electronic device. The cloud server comprises a memory for storing instructions; and a processor having access to a microphone of an electronic device and the memory which stores the instructions executable by the processor to: receive a first audio input from the electronic device; activate an audio controlled function of the electronic device, in response to the first audio input satisfying a triggering condition; instruct the microphone to obtain a second audio input after obtaining the first audio input; receive the second audio input; obtain a processing result of the second audio input; instruct the electronic device to respond to the second audio input in response to the processing result indicating the second audio input is an audio control for the electronic device; and instruct the electronic device to ignore the second audio input in response to the processing result indicating the second audio input is not an audio control for the electronic device.

The present disclosure provides a processing method of audio control for an electronic device. When a first voice as detected in monitoring process satisfies a triggering condition, an audio control function of the electronic device may be activated. After obtaining the first audio input, the electronic device may be configured to obtain a second audio input, and a processing result of the second audio input. If the processing indicates the second audio input is an audio control issued by a user with respect to the electronic device, the second audio input may be responded to. Otherwise, the second audio input may be ignored. Accordingly, embodiments of the present disclosure reduce mis-operations during which the electronic device takes subsequent audio inputs as control instructions by mistakes and performs unintended control operations.

### BRIEF DESCRIPTION OF THE DRAWINGS

The following drawings are merely examples for illustrative purposes according to various disclosed embodiments and are not intended to limit the scope of the present disclosure.

FIG. 1 is a flow diagram of a processing method of audio control consistent with the disclosed disclosure;

FIG. 2 shows a flow diagram of the steps in the processing method to obtain the processing result indicating whether the second audio input corresponds to the at least one control instruction used for performing a control operation on the electronic device; and

FIG. 3 shows a structural schematic diagram of an electronic device implementing the processing method according to the present disclosure.

### DETAILED DESCRIPTION

Reference will now be made in detail to exemplary embodiments of the present disclosure, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the claims.

The present disclosure provides a processing method of audio control, which may be applied to an electronic device. The electronic device herein may refer to a mobile phone, a tablet PC, a PDA (Personal Digital Assistant), a POS (Point of Sales), a vehicle computer (or Car PC), a computer, a smart home terminal, or any other terminal equipment.

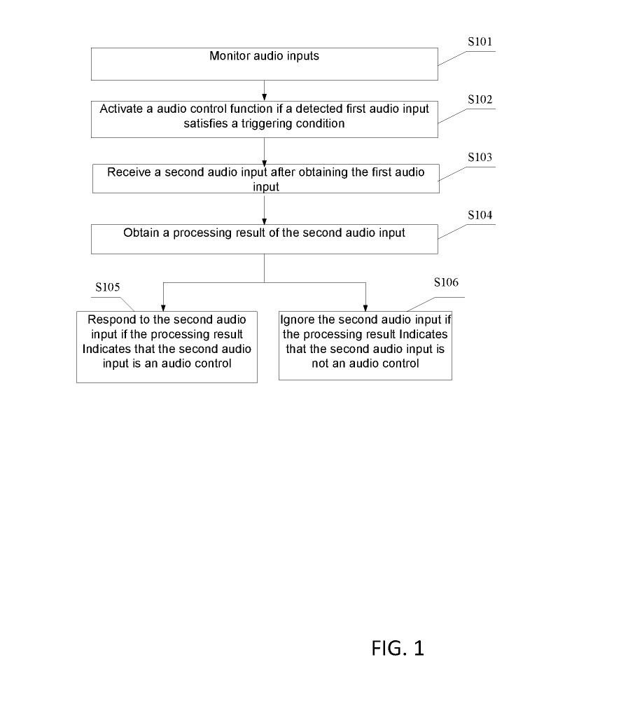

A flow chart of the procession method is depicted in FIG. 1. As illustrated in FIG. 1, the processing method of the present disclosure comprises the following steps.

Step S101: monitoring audio inputs.

To continuously monitor audio input, a voice monitoring function of the electronic device may be configured to remain on. As a result, the electronic device is capable of real-time monitoring of audio inputs.

Step 102: activating an audio control function of the electronic device, if a first audio input is detected and satisfies a triggering condition.

The triggering condition may be set as a condition in which the first audio input includes a word or a phrase to wake up the electronic device, or in which the first audio input includes at least one control instruction for controlling and activating the audio input control function.

That is, in the monitoring process, if the detected first audio input satisfies the triggering condition, the audio control function of the electronic device may be activated. After the first audio input is detected and obtained, the electronic device may enter a state waiting for subsequent audio inputs. In some instances, upon receiving the subsequent audio inputs, those audio inputs may be transmitted to a cloud sever for speech recognition processing of the audio inputs. In some instances, however, the electronic device may perform a speech recognition by itself to determine whether a control operation on itself is required based on the subsequent voice inputs. The audio control function herein may refer to a function which the electronic device is able to perform in response to the first audio input satisfying the triggering condition.

Consistent with the present disclosure, the electronic device may detect a variety of audio inputs which do not satisfy the triggering condition prior to the first audio input. For example, the electronic device may detect a first audio input “Xiao Le” (i.e., the name of the electronica device). Before this first audio input is detected, the electronics device may have detected other audio inputs, such as “I have finished my meal” or “It was delicious.” These audio inputs may be categorized as audio inputs not activating the audio control function. In some instances, if the audio control function of the electronic device is not activated, the electronic device may be configured to remain in a state in which the electronic device conducts a continuous monitoring audio input task to determine whether the triggering condition is satisfied. That is, the electronic device may be in a state searching for the first input to satisfy the triggering condition.

Step 103: acquiring a second audio input after obtaining the first audio input.

Step 104: obtaining a processing result of the second audio input.

In some instances, the electronic device may transmit the obtained second audio input to a cloud sever to analyze and process on the second audio input, and send a processing result of the second audio input back to the electronic device. The cloud sever may remain in a speech recognition state. That is, upon receiving the second audio input transmitted from the electronic device, the cloud server may perform a data analysis on the second audio input in real time. Otherwise, the cloud sever may be in a state waiting for audio inputs. In other embodiments, the electronic device may process the second audio input by itself to obtain the processing result.

Step 105: responding to the second audio input if the processing result of the second audio input indicates the second audio input satisfying a first condition. The first condition may indicate that the second audio input is an audio control for the electronic device.

Step 106: ignoring the second audio input if the processing result of the second audio input indicates the second audio input satisfying a second condition. The second condition may indicate that the second audio input is not an audio control for the electronic device.

Regarding the second audio input, it is noted that either Step 105 or Step 106 may be performed in one scenario. Step 105 and Step 106 are not performed simultaneously. Further, Step 105 and Step 106 are not performed in a specific order, and either Step 105 or Step 106 may be selected to perform each time.

As the triggering condition is met, the electronic device may be activated and waiting for subsequent audio inputs. In some instances, the electronic device might be triggered by mistake. For example, after the user makes the first audio input “Xiao Le” (i.e., the name of the electronic device), he may then explain to another person “that would be how you activate the electronic device.” The second audio input “that would be how you activate the electronic device” is not an audio control for the electronic device. Under certain circumstances, even if the subsequent audio inputs are not issued by a user to perform a control operation on the electronic device, the electronic device may still respond to the audio inputs. In view of this, the present disclosure provides processing methods in which the second audio input may be ignored if the processing result of the second audio input shows that the second audio input is not an audio control for the electronic device. Accordingly, the performance of the electronic device can be enhanced.

In some embodiments, if the processing result indicates that the second audio input satisfies the second condition where the second audio input is not an audio control, the audio control function may be turned off after ignoring the second audio input. As such, the electronic device may be reset to a state where the audio control function is not activated. Based on this setting, the electronic device may be set to return to Step 101 to start monitoring audio inputs again. If a first audio input satisfying the triggering condition is detected again, the voice function control may be activated again.

In embodiments of the present disclosure, misoperations can be accordingly reduced. If the second audio input is not an audio control for the electronic device, it is very possible that a third audio input received after the second audio input is not an audio control issued with respect to the electronic device either. In order to prevent the electronic device from looping from Step 103 to Step 106, by turning off the audio control function, duplicate or meaningless operations can be filtered out, thereby improving data processing efficiency of the electronic device.

As stated, in response to detecting the first audio input that satisfies the triggering condition, the audio control function of the electronic device is activated to acquire the second audio input after obtaining the first audio input. The processing result of the second audio input is then obtained. If the processing result indicates that the second audio input is an audio control issued with respect to the electronic device, the electronic device may respond to the second audio input. However, if the processing indicates that the second audio input is not an audio control for the electronic device; the second audio input may be ignored. As such, if the electronic device is activated by mistakes, the misoperations on the electronic device in response to the subsequent second audio input can be avoided or reduced.

There may be a variety of ways to realize the step of “obtaining the processing result of the second audio input.” The present disclosure provides examples herewith, but not limited thereto. One is to first obtain a first processing result of the second audio input, in which the first processing result indicates whether the second audio input corresponds to at least one control instruction used for performing a control operation on the electronic device. And a second processing result of the second audio input may be further obtained, if the first processing result indicates the second audio input is not corresponding to the at least one instruction. The second processing result may indicate that the second audio input satisfies the first condition where the second audio input is an audio control, or the second condition where the second audio input is not an audio control.

In some applications, the first processing result may represent that the second audio input does not correspond to at least one control instruction for performing a control operation on the electronic device. In some cases, the electronic device does not recognize the second audio input. In other words, the electronic device does not “hear” the second audio input clearly, so it cannot be determined which control instruction the second audio input corresponds to. In other cases, the electronic device recognized the second audio input. Namely, the electronic device already “heard” the second audio input. However, the electronic device cannot recognize which control instruction the second audio input corresponds to.

The term “one control instruction for the electronic device” in the present disclosure may refer to those control instructions corresponding to functions supported by the electronic device. Different functions exist in different electronic devices. And different functions correspond to different control instructions. Taking speakers for instance, the control instructions corresponding to functions supported by a smart speaker may include: “on”, “off”, “play previous song”, “play next song”, “pause”, “increase volume”, “decrease volume”, “play a specific song of . . . ”, or the like. As another example, the control instructions corresponding to functions supported by a smart air-conditioning system may comprise: “on”, “off”, “set a temperature”, “temperature down”, “temperature up”, or the like. In some instances, the phrase of “one control instruction for the electronic device” mentioned in the present disclosure might not include a prompt issued by the electronic device to request for a re-input if the second audio input is not recognized.

In the situation where the first processing result indicates that the second audio input does not correspond to the at least one control instruction of a control operation on the electronic device, it is possible that the second audio input is not an audio control issued with respect to the electronic device; or it is also possible that the second audio input is indeed an audio control issued with respect to the electronic device.

Regarding the first case where the second audio input is not an audio control issued with respect to the electronic device, often the user is prompted for a re-input, which might be annoying. In view of this, the present disclosure provides the processing method in which the second processing result of the second audio input is obtained. The second processing result indicates whether the second audio input satisfies the first condition where the second audio input is an audio control, or the second condition where the second audio input is not an audio control.

If the second audio input is an audio control with respect to the electronic device, a prompt may then be outputted to show the first processing result, requesting the user to re-input. If the second audio input is not an audio control with respect to the electronic device, the second audio input may be ignored.

One way to obtain the processing result of the second audio input is to first obtain the first processing result of the second audio input. If the first processing result indicates that the second audio input does not correspond to the at least one control instruction, the second processing result of the second audio input is then obtained.

It is understood that the first processing result may indicate that the second audio input corresponds to the at least one control instruction of a control operation on the electronic device. Under this condition, it is still possible is that the second audio input is not an audio control with respect to the electronic device, while it is also possible that the second audio input is an audio control with respect to the electronic device.

If the first processing result indicates that the second audio input corresponds to the at least one control instruction of a control operation on the electronic device, and the second audio input is an audio control with respect to the electronic device, the electronic device may respond to the second audio input which corresponds to the at least one control instruction.

Taking speakers for instance, if the second audio input of “play next song” is issued by a user, the first processing result indicates that the second audio input corresponds to the control instruction of “play next song”; the electronic device may response to the control instruction of “play next song” and accordingly plays next song.

In short, if the processing result indicates that the second audio input satisfies the first condition, the situations the second audio input being responded may include the following situations.

The first case: if the second processing result indicates that the second audio input satisfies the first condition, and the first processing result indicates that the second audio input does not correspond to the at least one control instruction of a control operation on the electronic device, a prompt may be outputted to show the first processing result. For example, the first audio input of “Xiao Le” may already have triggered the electronic device, and the second audio input of “have a party” is subsequently obtained. The first processing result of the second audio input shows that the second audio input does not correspond to any control instruction. And the second processing result indicates that the second audio input is an audio control issued by a user with respect to the electronic device. The electronic device may then prompt the user that “have a party” cannot be processed by itself and request for a re-input.

The other case: if the second processing result indicates the second audio input satisfying the first condition, and the first processing result indicates that the second audio input correspond to the at least one control instruction of a control operation on the electronic device, the second audio input corresponding to at least one control instruction is responded.

In some embodiments, the second processing result may be first obtained. If the second processing result indicates that the second audio input satisfies the first condition, the first processing result of the second audio input may be further obtained. And, when the second processing result indicates that the second audio input satisfies the second condition, the second audio input may be directly ignored. Accordingly, the performance of audio control can be enhanced. For example, the second audio input of “have a party” may be a machine language, which is not issued with respect to the electronic device. After obtaining the second processing result to show this fact, the second audio input can be ignored at the current stage without further processing the second audio input to get the first processing result.

Furthermore, in some examples where the second audio input is indeed a series of control instructions for performing more than one control operations on the electronic device, if, at first, the second processing result determines the second audio input corresponding to an audio control with respect to the electronic device, the processing method may include steps to parse the second audio input into several control instructions for the electronic device to execute the control operations serially, without confirming the second processing result for each of the control instructions.

In summary, if the second processing result indicates that the second audio input satisfies the first condition, the first processing result is further obtained. If the first processing result indicate that the second audio input does not correspond to the at least one control instruction of a control operation on the electronic device, a prompt to show the first processing result may be outputted. When the first processing result indicates that the second audio input corresponds to a control instruction of a control operation on the electronic device, the second audio input corresponding to the at least one control instruction may be responded to.

In other embodiments, the first processing result and the second processing result may be obtained simultaneously, but not limited thereto.

Regarding the step of “obtaining a second processing result of the second audio input”, the first scenario is that, as long as the second audio input is in a range of human voice, it may be determined that the second audio input satisfies the first condition. Otherwise, the second audio input may be regarded as satisfying the second condition. Whether the second audio input is from human may be judged by a feature range of human voices, for example, in terms of decibel or frequency. Based on decibel, 1 dB is the volume human ears start to hear. Audio input below 20 dB, to humans, is defined as being under a very quiet environment. Audio input between 20˜40 dB is regarded as soft whisper. Audio input between 40˜60 dB is categorized as a normal conversion audio input range. Audio input above 60 dB may be inferred as noisy arguments. Audio input above 70 dB starts to damage human hearing nerves. Audio input above 90 dB might make human hearing impaired. And when staying in a space full of audio input between 100˜120 dB, humans might have a temporary hearing loss within several minutes. In terms of the above scales, a feature range of human voices may include audio inputs ranged from 40˜60 dB. In terms of frequency, a feature range of human voices may include frequencies ranged from 100 Hz (bass)˜10000 Hz (soprano).

In a summary, the step of “obtaining the second processing result of the second audio input” may comprise: obtaining the second processing result of the second audio input to determine whether an audio input feature of the second audio input corresponds to a feature range of human voices. If the audio input feature of the second audio input falls into and corresponds to the feature range of human voices, the second processing result indicates that the second audio input satisfies the first condition where the second audio input is an audio control. As stated, the range of human voices may be established based on a variety of properties of human voices, e.g. decibel or frequency, but not limited thereto. If the audio input feature of the second audio input fails to show the feature range of human voices, however, the second audio input is determined satisfying the second condition where it is not an audio control.

In a second scenario to obtain the second processing result, it may be assumed that the electronic device is controlled by one or one specific group of users for audio control. In some specific situations, the electronic device may be controlled only by a family or a group of people in one institute. Accordingly, audio input features of the user(s) may be pre-stored in electronic storage apparatuses. If an audio input feature of the second audio input corresponds to a pre-stored audio input feature of at least one user, the second audio input is determined being issued by the at least one user. In that case, the second audio input is regarded as an audio control with respect to the electronic device. If the audio input feature does not match or correspond to the pre-stored audio input feature of the at least one user, however, the second audio input is determined not being issued by the at least one user. Namely, the second audio input is not regarded as an audio control with respect to the electronic device. In some specific applications, the second scenario may be applied to those electronic devices in need of a relatively high security level, such as a smart safety box, a smart security door, etc.

In view of the foregoing, the step of “obtaining the second processing result of the second audio input” may comprise: obtaining the second processing result of the second audio input to determine whether an audio input feature of the second audio input corresponds to a pre-stored audio input feature of at least one user. If the audio input feature of the second audio input corresponds to the pre-stored audio input feature of the at least one user, the second audio input is determined satisfying the first condition where the second audio input is an audio control. However, if the audio input feature of the second audio input does not correspond to the pre-stored audio input of the at least one user, the second processing result indicates that the second audio input satisfying the second condition where the second audio input is not an audio control.

The term of “audio input feature” herein may comprise characteristics of human audio inputs. It may refer to one or more selected from the group consisting of voiceprint, dB, frequency, tone, pitch, and audio input intensity.

Among the audio input feature as listed above, voiceprint is an acoustic spectrum carrying acoustic information conducted and displayed by acoustic equipment. Different voiceprints exist in different humans. Further, due to various speaking habits, speech frequency and decibel of two humans would not be identical. Therefore, voiceprint is unique for each human and may be used as a distinguishing feature.

The second way to obtain the processing result of the second audio input may comprise: obtaining the processing result of the second audio input indicating whether the second audio input corresponds to at least one control instruction used for performing a control operation on the electronic device. If the second audio input corresponds to the at least one control instruction, the processing result indicates the second audio input satisfying the first condition. However, if the second audio input does not correspond to the at least one control instruction, the processing result of the second audio input indicates the second audio input satisfying the second condition.

It can be understood that, in the case where the second audio input is not an audio control with respect to the electronic device, generally, the possibility is pretty low that the second audio input corresponds to at least one control instruction of a control operation on the electronic device. Accordingly, if the second audio input corresponds to the at least one control instruction of a control operation on the electronic device, the second audio input may be regarded as an audio control for the electronic device. However, if the second audio input does not correspond to the at least one control instruction of a control operation with respect to the electronic device, the second audio input may thus be regarded as not an audio control for the electronic device. Thus, further processing of the second audio input can be omitted.

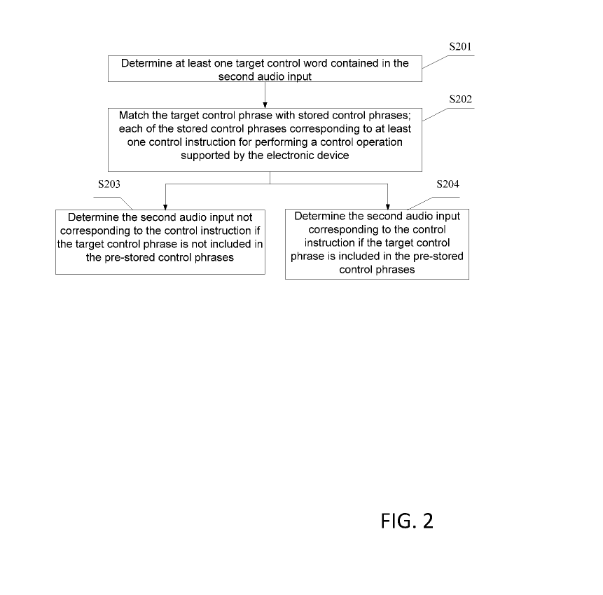

As illustrated in FIG. 2, the present disclosure provides the processing method to obtain the processing result indicating whether the second audio input corresponds to the at least one instruction used for performing a control operation on the electronic device. Those steps as shown in FIG. 2 may comprise:

Step 201: determining at least one target control phrase contained in the second audio input.

Assuming that the electronic device is a speaker and the second audio input is “play next song”, the electronic device may first recognize the second audio input. Further, a text corresponding to the second audio input may be parsed. For example, the second audio input may be parsed into “play”, “next”, “song”, “play next”, “next song”, and “play next song”, etc. These words may be organized as the at least one target control phrase contained in the second audio input, and number of the target control phrases that the second audio input corresponds to may be one or more.

Step S202: matching the at least one target control phrase with pre-stored control phrases. Each of the pre-stored phrases corresponding to at least one control instruction for performing a control operation supported by the electronic device.

Step S203: determining the second audio input does not corresponding to the at least one control instruction for the electronic device if the at least one target control phrase is not included in the pre-stored control phrases.

Step S204: determining the second audio input corresponds to at least one control instruction for the electronic device if the target control phrase is included in the pre-stored control phrases.

In the situation of the electronic device being a speaker, the pre-stored control phrases may include, for example, “previous song”, “pause”, “off”, “on”, next song”. Taking “play next song” as a specific example, but not limited thereto, a target control phrase of “next song” is contained in the list of the pre-stored control phrases. Accordingly, it is determined that the second audio input corresponds to the at least one control instruction of a control operation on the electronic device. And the control instruction corresponds to the instruction of “play next song”.

In other cases where the second audio input does not contain any from the pre-stored control phrases, the second audio input is regarded as not an audio control with respect to the electronic device.

The present disclosure also provides an electronic device as described with reference to the above embodiments regarding the processing method.

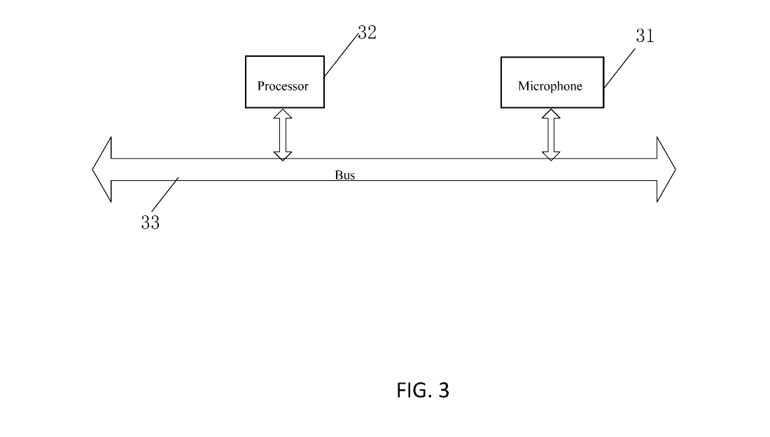

As illustrated in FIG. 3, it shows a structural schematic diagram of the electronic device provided by the present disclosure. The electronic device comprises a processor 32 and a microphone 31 coupled to the processor 32. The microphone 31 is configured for monitoring audio inputs. And the processor 32 is configured for activating an audio control function of the electronic device in the case of a first audio input satisfying a triggering condition. The processor 32 is further configured for controlling the microphone 31 to obtain a second audio input after obtaining the first audio input, and obtaining a processing result of the second audio input. If the processing result of the second audio input indicates the second audio input satisfying a first condition, the processor 32 may respond to the second audio input. However, the processor 32 may ignore the second audio input if the processing result of the second audio input indicates the second audio input satisfying a second condition. The first condition herein is used to indicate that the second audio input is not an audio control with respect to the electronic device, while the second condition indicates that the second audio input is not an audio control.

The processor 32 herein may refer to a central processor unit (CPU), an application specific integrated circuit (ASIC), at least one integrated circuit configured to achieve at least one embodiment of the present disclosure. The electronic device provided by the present disclosure may further comprise a communication bus 33, wherein the microphone 31 and the processor 32 communicate with each other through the communication bus 33.

In obtaining the processing result of the second audio input, the processor 32 may be further configured for obtaining a first processing result of the second audio input, and obtaining a second processing result of the second audio input if the first processing result indicates the second audio input does not correspond to the at least one control instruction. The first processing result is used to indicate whether the second audio input corresponds to at least one control instruction for performing a control operation on the electronic device, while the second processing result may indicate whether the second audio input satisfies the first condition or the second condition.

In order to respond the second audio input if the processing result indicates the second audio input satisfying the first condition, the processor 32 may be configured for outputting a prompt to show the first processing result, if the second processing result indicates the second audio input satisfies the first condition, and the first processing result of the second audio input indicates the second audio input not corresponding to the at least one control instruction for performing a control operation on the electronic device. The processor 32 may be configured for responding to the second audio input corresponding to the at least one control instruction, if the second processing result indicates the second audio input satisfying the first condition, and the first processing result of the second audio input corresponds to the at least one control instruction. The “outputting a prompt” and “responding to the second audio input” operations of the processor 32 may be performed individually or in a combination manner. The prompt may outputted in the case where the second processing result shows the second audio input satisfying the first condition, but the first processing result shows that the second audio input does not correspond to any of the control instruction. In that case, the prompt may be displayed to notify a user of the first processing result and requests for a re-input.

In order to obtain the second processing result of the second audio input, the processor 32 may be configured to obtain the second processing result of the second audio input to determine whether an audio input feature of the second audio input corresponds to a feature of human voices. That is, the second processing result of the second audio input is determined satisfying the first condition, if the audio input feature of the second audio input corresponds to the feature range of human voices. However, the second processing result is determined satisfying the second condition, if the audio input feature of the second audio input does not correspond to the feature range of human voices.

In other instances, the processor 32 may also be configured to obtain the second processing result of the second audio input to determine whether an audio input feature of the second audio input corresponds to a pre-stored audio input feature of at least one user. The second processing result of the second audio input may be determined to satisfy the first condition, if the audio input feature of the second audio input corresponds to the pre-stored audio input feature of the at least one user. However, the second processing result of the second audio input may be determined to satisfy the second condition, if the audio input feature of the second audio input does not correspond to the pre-stored audio input feature of the at least one user.

In some embodiments, the processor 32 may further be configured to obtain the processing result of the second audio input indicating whether the second audio input corresponds to at least one control instruction used for performing a control operation on the electronic device. The processing result of the second audio input may be determined to satisfy the first condition, if the second audio input corresponds to the at least one control instruction used for performing a control operation on the electronic device, However, the processing result may be determined to satisfy the second condition, if the second audio input does not correspond to the at least one control instruction used for performing a control operation on the electronic device.

In order to obtain the processing result indicating whether the second audio input corresponds to the at least one control instruction, in other instances, the processor 32 may be configured to determine at least one target control phrase contained in the second audio input. The processor 32 may be further configured to compare or match the target control phrase with pre-stored control phrases. And each of the pre-stored phrases corresponding to at least one control instruction for performing a control operation is supported by the electronic device. The second audio input may be determined to be not corresponding to the at least one control instruction, if the target control phrase is not included in the pre-stored control phrases. However, the second audio input may be determined to be corresponding to the at least one control instruction, if the target control phrase is included in the pre-stored control phrases.

Upon the step of ignoring the second audio input if the processing result of the second audio input satisfies the second condition, the processor 32 may be further configured to turn off the audio control function.

It should be understood that the terms of “first”, “second”, “third” and the like in the specification, claim and drawings of the present disclosure are used to distinguish different elements and not to describe a particular order. And the terms of “comprise”, “include”, “contain”, and any variation refer to a non-exclusive inclusion, not limited to the elements expressly described herewith.

The foregoing is intended to be a specific embodiment of the disclosure, but the scope of the disclosure is not limited thereto. It will be readily apparent to those skilled in the art within the technical scope of the present disclosure to modify or replace. These modifications or substitutions should be covered within the scope of the present disclosure. Accordingly, the protection scope of the present disclosure should be based on the scope of the claims in the following.

What is claimed is:

1. A method comprising:
receiving, using a processor, a first audio input;
activating, using a processor, an audio controlled function of an electronic device in response to the first audio input;
receiving, using a processor, a second audio input;
determining, using a processor, whether the second audio input is an audio control for the electronic device; and
responding, using a processor, to the second audio input in response to a determination result.

2. The method according to claim 1, further comprising:
obtaining, using a processor, a first processing result of the second audio input, the first processing result indicating whether the second audio input corresponds to a control instruction of the electronic device; and
obtaining, using a processor, a second processing result of the second audio input in response to the second audio input not corresponding to any control instruction of the electronic device, the second processing result indicating whether the second audio input satisfies a first condition or a second condition.

3. The method according to claim 2, further comprising:
outputting, using a processor, the first processing result, in response to the second audio input satisfying the first condition, and the first processing result indicating the second audio input does not correspond to any control instruction of the electronic device; and
responding, using a processor, to the second audio input corresponding to the control instruction, in response to the second processing result indicating the second audio input satisfies the first condition, and the first processing result indicating the second audio input corresponding to the control instruction.

4. The method according to claim 2, further comprising:
obtaining, using a processor, the second processing result of the second audio input to determine whether an audio input feature of the second audio input corresponds to a feature range of human voice, including:
determining, using a processor, that the second processing result indicates the second audio input satisfies the first condition in response to the audio input feature of the second audio input corresponding to the feature range of human voice; and
determining, using a processor, that the second processing result indicates the second audio input satisfies the second condition, in response to the audio input feature of the second audio input not corresponding to the feature range of human voice.

5. The method according to claim 4, wherein the feature range of human voice comprises at least one of a decibel range and a frequency range.

6. The method according to claim 2, further comprising:
obtaining, using a processor, the second processing result of the second audio input to determine whether an audio input feature of the second audio input corresponds to an audio input feature of at least one user, including:
determining, using a processor, that the second processing result indicates the second audio input satisfies the first condition, in response to the audio input feature of the second audio input corresponding to the audio input feature of the at least one user; and
determining, using a processor, that the second processing result indicates the second audio input satisfies the second condition, in response to the audio input feature of the second audio input not corresponding to the audio input feature of the at least one user.

7. The method according to claim 6, wherein: the audio input feature comprises one or more of voiceprint, decibel, frequency, tone, pitch, and audio input intensity.

8. The method according to claim 1, further comprising:
obtaining, using a processor, a first processing result of the second audio input indicating whether the second audio input corresponds to at least one control instruction of the electronic device, including:
determining, using a processor, that the first processing result indicates the second audio input satisfies the first condition, in response to the second audio input corresponding to the at least one control instruction of the electronic device; and
determining, using a processor, that the first processing result indicates the second audio input satisfies the second condition, in response to the second audio input not corresponding to any control instruction of the electronic device.

9. The method according to claim 8, further comprising:
determining, using a processor, at least one target control phrase contained in the second audio input;
comparing, using a processor, the at least one target control phrase with a set of control phrases, each of the set of control phrases corresponding to at least one control instruction of the electronic device;
determining, using a processor, the second audio input not corresponding to the at least one control instruction, in response to the at least one target control phrase not being in the set of control phrases; and
determining, using a processor, the second audio input corresponding to the at least one control instruction, in response to the at least one target control phrase being in the set of control phrases.

10. The method according to claim 9, wherein: the at least one target control phrase is determined by parsing, using a processor, a text corresponding to the second audio input into a phrase list and selected from the phrase list.

11. The method according to claim 3, further comprising:
obtaining, using a processor, the second processing result of the second audio input to determine whether an audio input feature of the second audio input corresponds to a feature range of human voice, including:
determining, using a processor, that the second processing result indicates the second audio input satisfying the first condition, in response to the audio input feature of the second audio input corresponding to the feature range of human voice; and
determining, using a processor, that the second processing result indicates the second audio input satisfying the second condition, in response to the audio input feature of the second audio input not corresponding to the feature range of human voice.

12. The method according to claim 3, further comprising:
obtaining, using a processor, the second processing result of the second audio input to determine whether an audio input feature of the second audio input corresponds to an audio input feature of at least one user, including:
determining, using a processor, that the second processing result indicates the second audio input satisfying the first condition, in response to the audio input feature of the second audio input corresponding to the audio input feature of the at least one user; and
determining, using a processor, that the second processing result indicates the second audio input satisfying the second condition, in response to the audio input feature of the second audio input not corresponding to the audio input feature of the at least one user.

13. The method according to claim 1, further comprising:
in response to the determination result indicating the second audio input is not an audio control for the electronic device, turning off, using a processor, the audio controlled function.

14. An electronic device, comprising:
a microphone;
a processor having access to the microphone and a memory which stores instructions executable by the processor to:
activate an audio controlled function of the electronic device, in response to receiving a first audio input satisfying a triggering condition;
instruct the microphone to obtain a second audio input after obtaining the first audio input;
receive the second audio input;
obtain a processing result of the second audio input;
respond to the second audio input in response to the processing result indicating the second audio is an audio control for the electronic device; and
ignore the second audio input in response to the processing result indicating the second audio input is not an audio control for the electronic device.

15. The electronic device according to claim 14, wherein the processor further executes the instructions stored in the memory to:
obtain a first processing result of the second audio input, the first processing result indicating whether the second audio input corresponds to at least one control instruction of the electronic device; and
obtain a second processing result of the second audio input, in response to the first processing result indicating the second audio input not corresponding to any control instruction, the second processing result indicating whether the second audio input satisfies a first condition or a second condition.

16. The electronic device according to claim 14, wherein the processor further executes the instructions stored in the memory to:
obtain the processing result of the second audio input indicating whether the second audio input corresponds to at least one control instruction for the electronic device;
determine that the processing result indicates the second audio input satisfying the first condition in response to the second audio input corresponding to the at least one control instruction for the electronic device; and
determine that the processing result indicates the second audio input satisfying the second condition in response to the second audio input not corresponding to any control instruction for the electronic device.

17. A cloud server, comprising:
a memory for storing instructions;
a processor having access to a microphone of an electronic device and the memory which stores the instructions executable by the processor to:
receive a first audio input from the electronic device;
activate an audio controlled function of the electronic device, in response to the first audio input satisfying a triggering condition;
instruct the microphone to obtain a second audio input after obtaining the first audio input;
receive the second audio input;
obtain a processing result of the second audio input;
instruct the electronic device to respond to the second audio input in response to the processing result indicating the second audio input is an audio control for the electronic device; and
instruct the electronic device to ignore the second audio input in response to the processing result indicating the second audio input is not an audio control for the electronic device.
